(19) United States
(12) Patent Application Publication
(10) Pub. No.: US 2011/0314409 A1
(43) Pub. Date: Dec. 22, 2011

(54) INFORMATION TERMINAL, COMPUTER PROGRAM PRODUCT AND METHOD THEREOF

(75) Inventor: Keijiro Yano, Tachikawa-shi (JP)

(73) Assignee: KABUSHIKI KAISHA TOSHIBA, Tokyo (JP)

(21) Appl. No.: 13/099,054

(22) Filed: May 2, 2011

(30) Foreign Application Priority Data
Jun. 18, 2010 (JP) 2010-139210

(51) Int. Cl. G06F 3/00

(52) U.S. Cl. 715/778

(57) ABSTRACT

According to one embodiment, an information terminal is capable of connecting to a network, and includes an associating module and a display module. The associating module associates a virtual desktop with network identification information. The display module displays, according to network identification information acquired when the information terminal is connected to the network, a virtual desktop associated with the network identification information.

### CROSS-REFERENCE TO RELATED APPLICATIONS

This application is based upon and claims the benefit of priority from Japanese Patent Application No. 2010-139210, filed Jun. 18, 2010, the entire contents of which are incorporated herein by reference.

### FIELD

Embodiments described herein relate generally to an information terminal, and a computer product and a method thereof.

### BACKGROUND

Information terminals such as common personal computers and mobile phones are usually provided with a graphical user interface (GUI), which allows the users to perform desired operation through the desktop environment set by the GUI. The desktop environment of the operating system (OS) for popular MS windows (registered trademark) PCs and the like cannot be actively changed to protect the consistency of user's experience. On the other hand, there have been proposed various virtual desktop environments (hereinafter, “virtual desktop”) to extend existing desktop environments.

The virtual desktop is a type of software that extend the desktop environment of a computer and provides the user with a plurality of independent virtual desktop environments, a continuous desktop space wider than the display area, and the like. The software that implements the virtual desktop generally has the functions of switching one virtual desktop to another for use, customizing the appearance of each virtual desktop, and the like. When the virtual desktops are arranged vertically/horizontally, the virtual desktops can be moved and switched.

The desired display mode of the desktop environment varies depending on the environment where it is used (for example, office, home, etc.). The desktop environment can be provided in a desired mode by preparing a plurality of virtual desktops in display modes corresponding to the use environments, respectively, and switching the virtual desktops.

In general, the user manually switches the virtual desktops through the touch panel or the keyboard.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary external view of a tablet personal computer (PC) according to an embodiment;

FIG. 2 is an exemplary block diagram of a hardware configuration of the tablet PC in the embodiment;

FIG. 3 is an exemplary schematic diagram of a software configuration in the embodiment;

FIG. 4 is an exemplary schematic diagram of a setting screen of a service set identifier (SSID) in the embodiment;

FIG. 5 is an exemplary schematic diagram of a virtual desktop in the embodiment;

FIG. 6 is an exemplary schematic diagram of a setting screen (desktop setting) to associate the virtual desktop with the SSID in the embodiment;

FIG. 7 is an exemplary schematic diagram of an additional menu in the embodiment;

FIG. 8 is an exemplary schematic diagram of a virtual desktop-SSID association table in the embodiment;

FIG. 9 is an exemplary flowchart of the operation of virtual desktop software upon switching the virtual desktop from one to another in the embodiment; and

FIG. 10 is an exemplary schematic diagram illustrating a specific example in which the virtual desktop is switched depending on the location in the embodiment.

### DETAILED DESCRIPTION

Various embodiments will be described hereinafter with reference to the accompanying drawings. In general, according to one embodiment, an information terminal is capable of connecting to a network, and comprises an associating module and a display module. The associating module is configured to associate a virtual desktop with network identification information. The display module is configured to display, according to network identification information acquired when the information terminal is connected to the network, a virtual desktop associated with the network identification information.

According to another embodiment, there is provided a method applied to an information terminal capable of connecting to a network and provided with a controller. The method comprises: associating a virtual desktop with network identification information by the controller; and displaying, according to network identification information acquired when the information terminal is connected to the network, a virtual desktop associated with the network identification information by the controller.

According to still another embodiment, a computer program product comprises a computer-readable storage medium having computer readable program codes embodied in the medium that, when executed, causes a computer to implement the above information terminal.

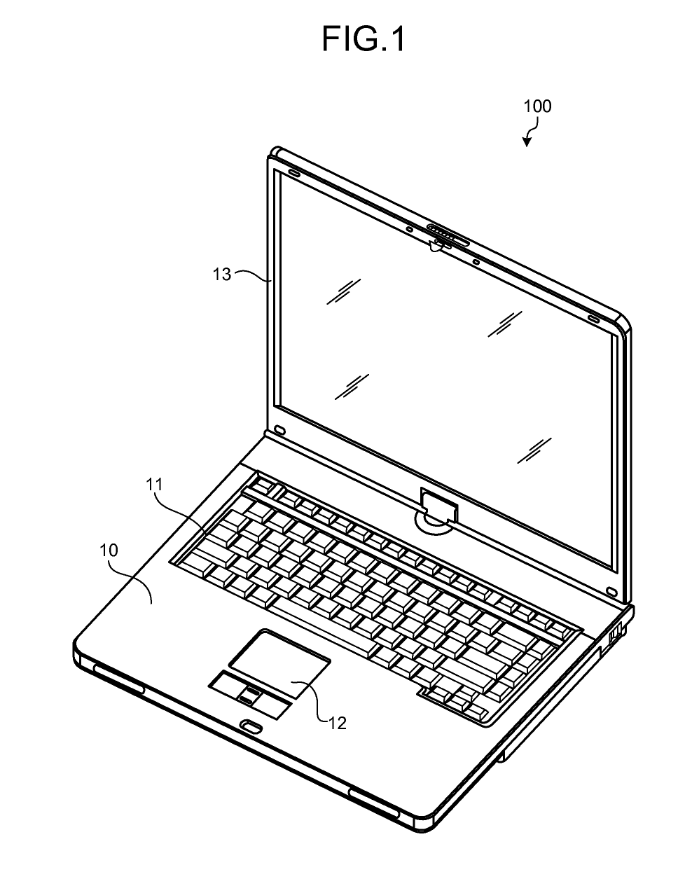

A description will be given of a tablet personal computer (PC) 100 according to an embodiment. FIG. 1 is an external view of the tablet PC 100 according to the embodiment.

The tablet PC 100 is a computer system comprising, as input devices, a keyboard 11, a touchpad 12, and a display device 13. The display device 13 comprises a touch panel on the front surface that detects the coordinate position of a pen or a finger and the contact area thereof.

As illustrated in FIG. 1, the tablet PC 100 has a main body 10 provided with the keyboard 11 and the touchpad 12. Various types of hardware is built in the main body 10 as described below.

The display device 13 further comprises a display panel (display screen) such as a liquid crystal display (LCD) panel. The tablet (touch panel) is provided integrally with the surface of the display panel. In the tablet PC 100, the display device 13 is attached to the main body 10 through a biaxial hinge mechanism to be rotatable between the open position and the closed position. FIG. 1 illustrates the display device 13 in the usual open position (laptop mode). The display device 13 can be rotated 180 degrees from the usual open position into the closed position (tablet mode) in such a manner as to cover the keyboard 11.

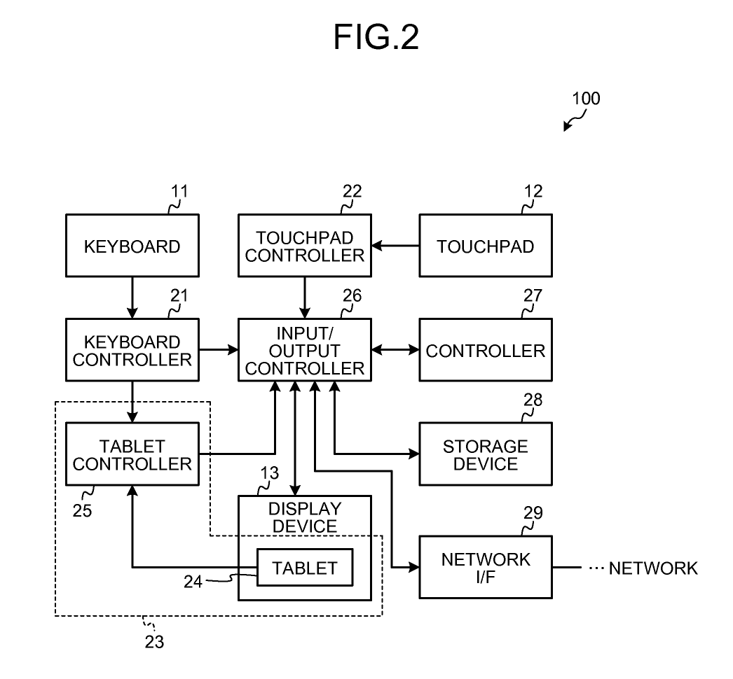

In the following, the hardware configuration of the tablet PC 100 will be described with reference to FIG. 2. FIG. 2 illustrates the hardware configuration of the tablet PC 100.

As illustrated in FIG. 2, the tablet PC 100 comprises a keyboard controller 21 and a touchpad controller 22. The keyboard controller 21 converts key input from the keyboard 11 into input data to be input to the main body 10. The touchpad controller 22 converts operation input from the touchpad 12 into input data to be input to the main body 10.

The tablet PC 100 further comprises a tablet input device 23 as a data input device in addition to the keyboard 11 and the touchpad 12. The tablet input device 23 comprises a tablet (touch panel) 24 and a tablet controller 25 that converts the coordinate position of a pen or a finger and the contact area thereof detected by the tablet 24 into input data.

The tablet PC 100 further comprises an input/output controller 26. The input/output controller 26 transfers data received from the keyboard controller 21, the touchpad controller 22, or the tablet controller 25 to a microprocessor, such as a central processing unit (CPU), of a controller 27. The input/output controller 26 also controls the output operation of the display device 13 and the input/output operation of a storage device 28 such as a hard disk drive (HDD) or a solid-state drive (SSD). The controller 27 comprises memory devices including a system memory, a basic input/output system (BIOS), a random access memory (ROM), and the like. The system memory comprises a random access memory (RAM) into which an operating system (OS) and various types of applications are loaded and which is used as a work area.

A network interface (I/F) 29 connected to the input/output controller 26 is an interface to connect to an external server (not illustrated) or the like via a network such as the Internet, a local area network (LAN), and the like. The tablet PC 100 can download a desired program or content from an external server or the like through the network I/F 29. In the embodiment, a wireless LAN is used as the network, the network may be a wired LAN.

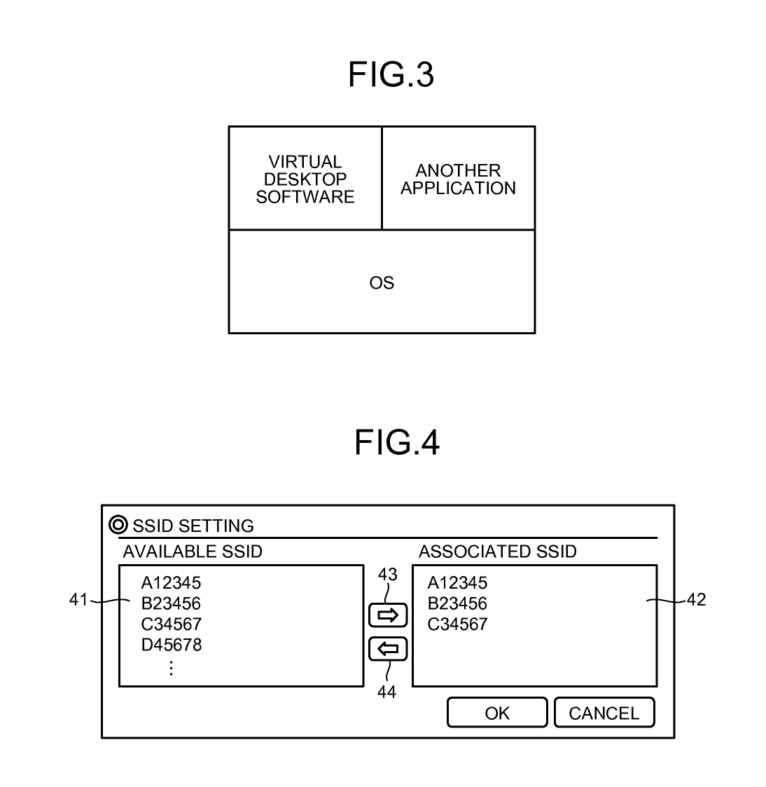

FIG. 3 illustrates the software configuration according to the embodiment. As illustrated in FIG. 3, virtual desktop software is installed on the operating system (OS) as basic software in parallel with other applications. The virtual desktop software performs the characteristic operation of the embodiment. The virtual desktop software is always executed, and is running in the background even when another application is executed.

In the following, a description will be given of the characteristic process and operation performed by the tablet PC 100 of the embodiment. In the embodiment, registration of a service set identifier (SSID) to be associated with each virtual desktop and setting of associating an SSID with each virtual desktop are performed in advance. These operations will be described first. Incidentally, the SSID is an identifier of an access point in IEEE 802.11 wireless LAN.

FIG. 4 illustrates an example of an SSID setting screen. If the user instructs to set an SSID on a virtual desktop currently offered, the setting screen as illustrated in FIG. 4 is displayed. A list of available SSIDs is displayed in an area 41 on the setting screen. The available SSIDs displayed at this time are the same SSIDs as provided by WiFi technology.

In FIG. 4, SSIDs registered to be associated with virtual desktops (to-be-associated SSIDs), respectively, are displayed in an area 42. When the user selects a desired SSID from the available SSIDs displayed in the area 41 and presses a registration button 43, the selected SSID is displayed in the area 42. To cancel the registration of a to-be-associated SSID displayed in the area 42, the user selects the to-be-associated SSID and presses a registration cancel button 44. With this, the to-be-associated SSID is deleted from a list of the to-be-associated SSIDs. When the user presses the OK button, the to-be-associated SSID list is stored in the storage device 28.

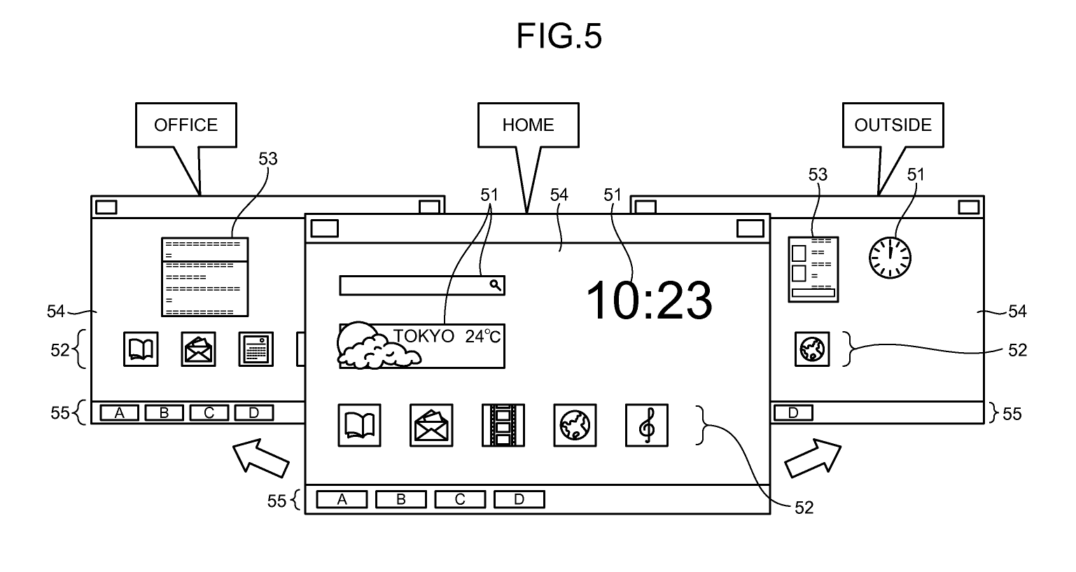

FIG. 5 illustrates an example of three virtual desktops. In the embodiment, while three virtual desktops (for home, for office, and for outside) will be described as being available, there maybe any number of virtual desktops. Different widgets 51, shortcut icons 52, live folders 53, and the like are displayed on the virtual desktops, respectively. On the other hand, a background image 54 and a launcher 55 are generally the same.

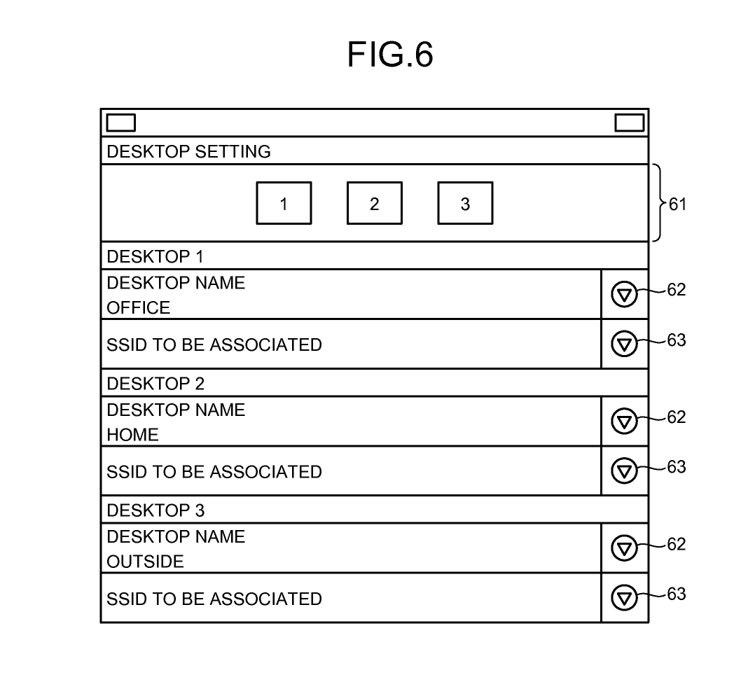

FIG. 6 illustrates an example of a setting screen (desktop setting) to associate a virtual desktop with an SSID. If the user instructs to set a desktop on a virtual desktop currently offered, the setting screen as illustrated in FIG. 6 is displayed.

In FIG. 6, numbers 1 to 3 corresponding to the three virtual desktops are displayed in an area 61. The virtual desktops are managed by the numbers, respectively.

A button 62 is used to open a text dialog box to input a desktop name of each virtual desktop. By pressing the button 62 and inputting a desired desktop name (for example, “office”, “home”, or “outside”) from the open text dialog box (not illustrated), the user can give a name that the user can easily remember to each virtual desktop.

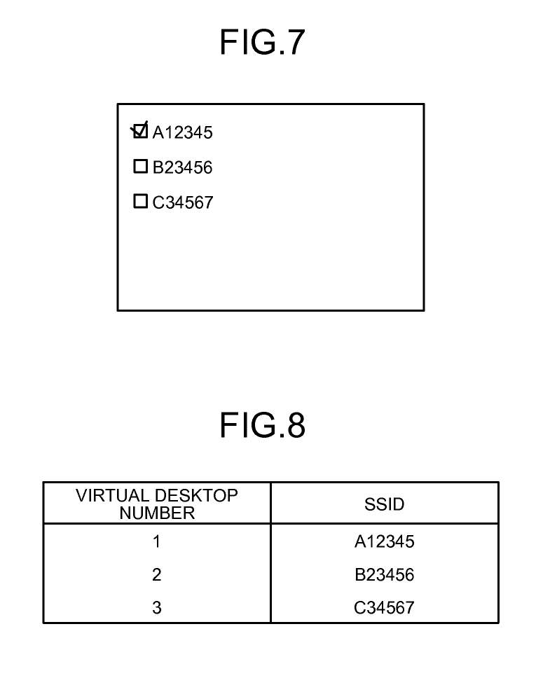

A button 63 is used to open an additional menu to set an SSID to be associated with each virtual desktop. FIG. 7 illustrates an example of the additional menu. As illustrated in FIG. 7, the additional menu displays a list of to-be-associated SSIDs (in the example of FIGS. 7, A12345, B23456, and C34567, see FIG. 4) stored in the storage device 28, and check boxes to select the to-be-associated SSIDs, respectively. By checking a check box, the user can associate a corresponding SSID with each virtual desktop. One SSID is associated with one virtual desktop, and an SSID already selected for a virtual desktop may be, for example, grayed out so that it cannot be selected. The number of each virtual desktop and an SSID associated therewith are, for example, registered in a virtual desktop-SSID association table as illustrated in FIG. 8, and stored in the storage device 28.

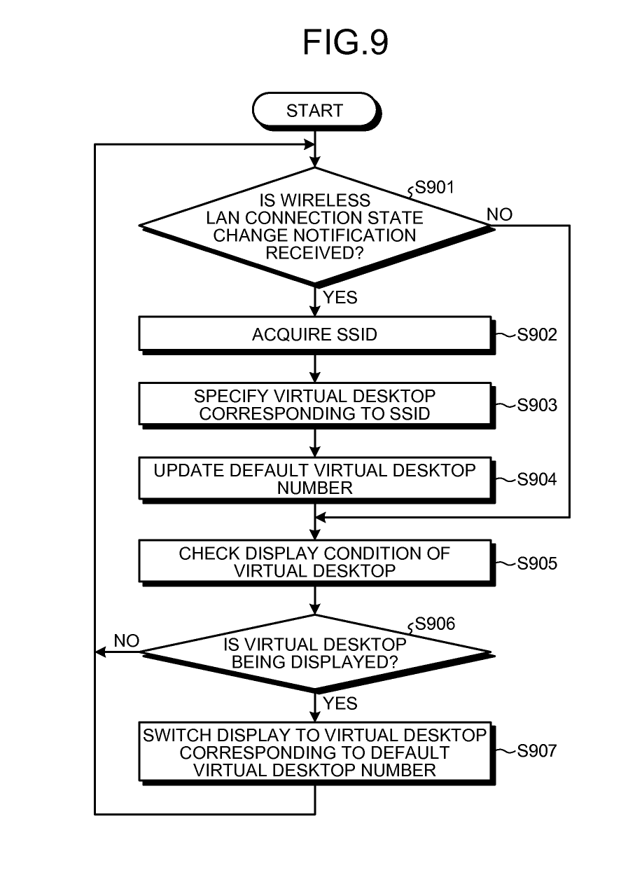

In the following, automatic switching of virtual desktops will be described with reference to FIG. 9. FIG. 9 is a flowchart of the operation of the virtual desktop software upon switching a virtual desktop to another.

While the following operation is performed by the CPU of the controller 27 according to the virtual desktop software, it will be described as being performed by the virtual desktop software for the simplicity of description. Although not included in the following process, virtual desktops can be switched by user operation using the touch panel or the keyboard (for example, by dragging a desktop screen on the touch panel). In this case, the number of the virtual desktop after the switching is set as a default virtual desktop number. Besides, the following process can be canceled.

In the embodiment, the automatic switching of virtual desktops is performed when the OS sends the virtual desktop software a wireless LAN connection state change notification notifying that there is a change in the state of the connection to the wireless LAN. The wireless LAN connection state change notification includes network identification information (in the embodiment, an SSID detected at the time of network connection).

First, the virtual desktop software determines whether a wireless LAN connection state change notification is received from the OS (S901).

If a wireless LAN connection state change notification is received from the OS (Yes at S901), the virtual desktop software acquires an SSID as network identification information (S902).

With reference to the virtual desktop-SSID association table, the virtual desktop software specifies a virtual desktop corresponding to the SSID acquired in response to the notification from the OS (S903). More specifically, the virtual desktop software specifies the number (1, 2, or 3) of the corresponding virtual desktop. It is assumed herein that the number of a virtual desktop when the wireless LAN connection state change notification notifies that network connection is not established or an unknown SSID is acquired is determined in advance (for example, the number of a virtual desktop for outside is used).

The virtual desktop software then rewrites and updates the default virtual desktop number with the number of the virtual desktop specified at S903 (S904). For example, the number of a virtual desktop for home is set as the initial value of the default virtual desktop number.

Next, the virtual desktop software checks the display condition of the virtual desktop on the display screen (S905). More specifically, the virtual desktop software checks whether the virtual desktop or another application is being displayed on the screen. In the embodiment, when opened, each application is displayed in full-screen mode. Accordingly, when another application is opened, the virtual desktop is not displayed.

When the virtual desktop is being displayed (Yes at S906), the virtual desktop software promptly switches the display to the virtual desktop corresponding to the default virtual desktop number rewritten at S904, i.e., corresponding to the acquired SSID (S907). If the currently displayed virtual desktop is the same as the virtual desktop corresponding to the default virtual desktop number rewritten at S904 as in the case, for example, when different SSIDs are associated with the same virtual desktop, the display is not changed. After that, the process returns to S901.

On the other hand, when the virtual desktop is not being displayed (No at S906), the virtual desktop software does not change the display because the virtual desktop is not being displayed. Thus, the process returns to S901. That is, in this case, only the default virtual desktop number is updated at S904, and the display screen does not change.

If a wireless LAN connection state change notification is newly received from the OS, the above process is performed again. Otherwise (No at S901), the virtual desktop software checks again the display condition of the virtual desktop on the display screen (S905). When the virtual desktop is being displayed as in the case, for example, when the non-displayed state of the virtual desktop changes to the displayed state (Yes at S906), the virtual desktop software switches the display to the virtual desktop corresponding to the default virtual desktop number (S907).

In the embodiment, each application is described as being displayed in full-screen mode when opened. Meanwhile, in the case of multi-window display, if a virtual desktop is displayed on the background of an open application, the virtual desktop is determined as being displayed, and the display of the background is switched to the virtual desktop corresponding to the default virtual desktop number.

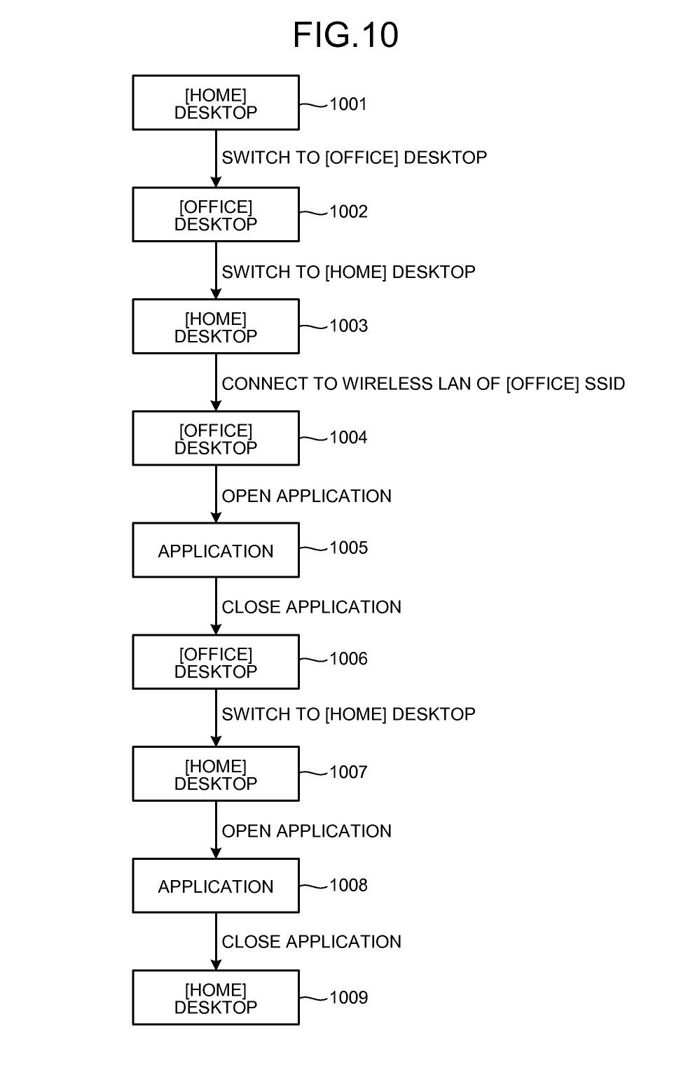

In this manner, a virtual desktop is automatically switched to another virtual desktop. In the following, with reference to FIG. 10, a specific example will be described in which a virtual desktop is switched to another depending on the location where the tablet PC 100 is used. FIG. 10 illustrates the specific example in which a virtual desktop is switched to another depending on the location.

It is assumed that, first, the user stays at home, and a virtual desktop for home (hereinafter, “[HOME] desktop”) is displayed (1001).

If the user switches the virtual desktop to a virtual desktop for office (hereinafter, “[OFFICE] desktop”) using the touch panel or the keyboard, the [OFFICE] desktop is displayed (1002).

Then, if the user switches the virtual desktop to the [HOME] desktop using the touch panel or the keyboard, the [HOME] desktop is displayed (1003).

At the office, if the user connects the tablet PC 100 to the wireless LAN, the virtual desktop is automatically switched to the [OFFICE] desktop corresponding to an SSID acquired at this time (it is herein assumed that the SSID is associated with the [OFFICE] desktop) (1004). At this point, if another application is opened, the virtual desktop is not displayed. Accordingly, the virtual desktop is not switched to the [OFFICE] desktop. When the application is closed, the virtual desktop is switched to the [OFFICE] desktop.

After the virtual desktop is switched to the [OFFICE] desktop, if another application is opened, the application is displayed (1005), and the [OFFICE] desktop is not displayed. When the application is closed, the [OFFICE] desktop is displayed again (1006).

Then, if the user switches the virtual desktop to the [HOME] desktop using the touch panel or the keyboard, the [HOME] desktop is displayed (1007).

At this point, if another application is opened, the application is displayed, while the [HOME] desktop is not displayed. When the application is closed, the [HOME] desktop is displayed again (1009).

As described above, according to the embodiment, based on an SSID (network identification information), the desktop is automatically switched to a virtual desktop associated with the SSID. Thus, it is possible to provide the user with optimal desktop environment depending on the location where the user uses the tablet PC.

While the tablet PC is described above as an example of the information terminal, the information terminal is not limited thereto. Examples of the information terminal include any type of personal computers, mobile phones, personal digital assistants (PDAs), and the like. While, in the embodiment, the virtual desktop is switched from one to another when the information terminal is connected to a wireless LAN based on an SSID for identifying a connection destination (access point), this is not so limited. For example, the virtual desktop maybe switched when the information terminal is connected to a wired LAN based on a media access control (MAC) address or the like.

The controller 27 that associates an SSID with each virtual desktop and registers it through the setting screen for associating an SSID with a virtual desktop functions as an associating module in the tablet PC 100. The controller 27 that performs S907 of the process flow described above functions as a display module in the tablet PC 100. The controller 27 that performs S904 of the process flow functions as a setting module that sets a virtual desktop associated with network identification information (SSID) as a default virtual desktop.

A computer program may be executed on a computer to automatically switch the virtual desktop from one to another. The computer program may be provided as being stored in advance in ROM or the like. The computer program may also be provided as being stored in a computer-readable storage medium, such as a compact disc-read only memory (CD-ROM), a flexible disk (FD), a compact disc recordable (CD-R), and a digital versatile disc (DVD), as a file in an installable or executable format. The computer program may also be stored in a computer connected via a network such as the Internet so that it can be downloaded therefrom via the network.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information terminal capable of connecting to a network, the terminal comprising:
a controller configured to associate a virtual desktop with network identification information; and
a display configured to display, according to network identification information acquired when the information terminal is connected to the network, the virtual desktop associated with the network identification information.

2. The information terminal of claim 1, wherein:
the controller is further configured to set the virtual desktop associated with the network identification information acquired when the information terminal is connected to the network as a first default virtual desktop, and
the display is further configured to display the first default virtual desktop set by the controller.

3. The information terminal of claim 2, wherein the display is configured to display a second default virtual desktop when the information terminal is not connected to the network or when unknown network identification information is acquired.

4. The information terminal of claim 1, wherein the network identification information comprises a service set identifier.

5. A computer program product comprising a computer-readable, non-transitory storage medium comprising code capable of causing a computer to implement an information terminal capable of connecting to a network and automatically switching virtual desktops, and to:
associate a virtual desktop with network identification information; and
display, according to network identification information acquired when the information terminal is connected to the network, the virtual desktop associated with the network identification information.

6. The computer program product of claim 5, wherein the storage medium further comprises code capable of causing the computer to:
set the virtual desktop associated with the network identification information acquired when the information terminal is connected to the network as a first default virtual desktop; and
display the first default virtual desktop associated with the network identification information.

7. The computer program product of claim 6, wherein the storage medium further comprises code capable of causing the computer to:
display a second default virtual desktop when the information terminal is not connected to the network or unknown network identification information is acquired.

8. The computer program product of claim 5, wherein the network identification information comprises a service set identifier.

9. A method comprising:
associating, by a controller, a virtual desktop with network identification information; and
displaying, on an information terminal capable of connecting to a network, the virtual desktop associated with the network identification information, according to network identification information acquired when the information terminal is connected to the network.

10. The method of claim 9, further comprising:
setting the virtual desktop associated with the network identification information acquired when the information terminal is connected to the network as a first default virtual desktop, and
displaying the first default virtual desktop associated with the network identification information.

11. The method of claim 10, further comprising:
displaying a second default virtual desktop when the information terminal is not connected to the network or unknown network identification information is acquired.

12. The method of claim 9, wherein the network identification information comprises a service set identifier.
